(19) United States
(12) Patent Application Publication
(10) Pub. No.: US 2024/0017205 A1
(43) Pub. Date: Jan. 18, 2024

(54) TWO STEP AMINE ABSORPTION PROCESS FOR REMOVAL CO2/H2S FROM BIOGAS

(71) Applicant: Airco Process Technology A/S, Fredericia (DK)

(72) Inventor: Rasmus FIND, Vejle (DK)

(73) Assignee: Airco Process Technology A/S, Fredericia (DK)

(21) Appl. No.: 18/037,277

(22) PCT Filed: Nov. 16, 2021
(86) PCT No.: PCT/EP2021/081882

§ 371 Date: May 16, 2023

(30) Foreign Application Priority Data
Nov. 16, 2020 (EP) 20207834.1

(51) Int. Cl. B01D 53/14; B01D 53/52; B01D 53/62; B01D 53/78; B01D 53/96; C10L 3/10

(52) U.S. Cl. CPC B01D 53/1406; B01D 53/1462; B01D 53/1425; B01D 53/526; B01D 53/62; B01D 53/78; B01D 53/96; C10L 3/104; C10L 3/103; B01D 2258/05; B01D 2257/304; B01D 2257/504; B01D 2256/245; B01D 2252/20484; B01D 2252/20405; B01D 2252/20421; B01D 2252/20489; B01D 2252/20431

(57) ABSTRACT

The present invention relates to a method for upgrading biogas, i.e. a method for removing carbon dioxide and/or hydrogen sulphide from biogas. Particularly the invention relates to a method for upgrading biogas by absorption in two absorbers, where the gas effluent of the first absorber is pressurized and fed to the absorber of the second absorption step and wherein the liquid effluents of the two absorbers are regenerated to form a regenerated absorption stream, which is then provided in two absorption streams which is fed to the absorber of the first and second absorption steps respectively. It also relates to a system for performing the method.

### CROSS-REFERENCE TO RELATED APPLICATIONS

The instant application is a U.S. National Stage application of and claims priority to PCT/EP2021/081882, filed on Nov. 16, 2021, which is a PCT application of and claims priority to EP Application No. 20207834.1, filed on Nov. 16, 2020, the subject matter of both aforementioned applications is hereby incorporated by reference in their entireties.

### FIELD OF TECHNOLOGY

The present invention relates to upgrading biogas comprising methane, carbon dioxide and optionally hydrogen sulphide. Biogas is gas generated by a biological process, such as an anaerobic biological process, and upgrading biogas refers to the removal of carbon dioxide and/or hydrogen sulphide from the biogas.

### BACKGROUND

Biogas is a gas produced by the biological decomposition of biomass and it comprises methane, carbon dioxide and hydrogen sulphide. The biomass can be waste streams from the agricultural industry, manure, sewage, landfills, food production or the like and as such biogas presents an opportunity to convert waste streams into a sustainable and valuable gas product which can be used e.g. as a fuel or a chemical feed in industrial processes or a precursor. Contrary to fossil gas, biogas is a renewable energy source. The biogas obtained from a biogas plant is typically provided at low pressures and contains significant amounts of carbon dioxide, hydrogen sulphide and water. The carbon dioxide content may be more than 30% by volume. Hence, utilization of the biogas requires purification, also known as upgrading, to meet gas quality standards and compression before it can be supplied to a gas grid or otherwise transported. The limits for carbon dioxide and hydrogen sulphide content of the biogas depend on the application, where production of liquified biogas (LBG) demands lower limits than gas of pipeline quality, e.g. due to the issue of carbon dioxide condensation/solidification in the liquifying systems. Therefore, there is an increasing interest in efficient processes for upgrading biogas. Such upgraded biogas is sometimes referred to as biomethane or renewable natural gas (RNG). “Biogas upgrading” as used herein refers to removal of undesired components, such as carbon dioxide and hydrogen sulphide.

Known processes for biogas upgrading are absorption processes and/or scrubbing processes wherein carbon dioxide and hydrogen sulphide in a biogas feed is absorbed in a liquid. Typical physical absorbents are methanol, DEPG, NMP and water and typical chemical absorbents are amines, but others are available. In such absorption processes some methane will also be absorbed, representing a methane loss in the process, which is an important factor for the commercial viability of a process. Another important factor is the regeneration of the absorbing media, where the absorbed gas is desorbed allowing the absorbing media to be reused.

For chemical absorption agents, regeneration is typically done by heating, stripping, or flash operations or combinations thereof. The degree of regeneration affects the achieved purity and represents significant utility and hence operational costs. As the required limits for carbon dioxide and/or hydrogen sulphide are lowered, the utility demand of the biogas upgrade process increases.

Biogas upgrade processes thus need to optimize the operational costs and capital costs while still satisfying the carbon dioxide and hydrogen sulphide limits of the product, and processes improving on these aspects present major economic and environmental advantages, in particular due to the typically large processing volumes.

In a typical known process, an absorber is fed sour biogas at the bottom and a lean amine solution fed at the top, whereby the streams are brought into contact in a counter-current flow. Sweet gas is recovered from the top of the absorber and the rich amine solution is retrieved from the bottom of the absorber. The rich amine solution is regenerated by heating and stripping it of absorbed gas in a stripper column, providing a lean amine solution which is then led to the absorber again. Lowering the carbon dioxide or hydrogen sulphide in the sweet gas can be achieved by increasing the liquid to gas ratio in the absorber or the degree of regeneration of the amine, both options increasing the operational costs.

Some biogas upgrade plant designs seek to lower operational costs of the regeneration process by splitting the rich amine stream in two and regenerating them to different degrees, which is sometimes referred to as split-flow processes. One such process is proposed in DE102009056660A1 where two absorbers are provided in series and the rich amine solution from the first absorber is split and regenerated in a flash process and a heating process respectively. The heating process generates a comparatively leaner amine solution which is used in the second absorber to polish the biogas, and the flash unit generates a less lean amine solution which is used in the first absorber. As only part of the amine solution is regenerated in the operationally expensive heating system, the efficiency of the process may be increased. However, a disadvantage of this process is that it requires a very lean amine solution for the second column to obtain high purity biogas, and as regeneration of the amine solution is a non-linear process in the sense that achieving the last degrees of regeneration requires more energy than the first, this can present significant operational costs. Furthermore, as the flash regeneration provides a less lean amine solution, a larger circulation rate of solvent may be required overall.

An object of the invention is to provide an improved or further process for upgrading biogas, and more preferably processes which improve on one or more of yield, utility consumption, capital costs while providing upgraded biogas satisfying quality limits.

### SUMMARY OF THE INVENTION

These and further objects are met in a first aspect of the invention providing a method for upgrading a biogas stream, the biogas stream comprising methane, carbon dioxide, and optionally hydrogen sulphide, the method comprising the steps of:
a. feeding the biogas stream and a first liquid absorption stream to an absorber of a first absorption step,
b. absorbing carbon dioxide, and hydrogen sulphide if present, from the biogas stream into the first liquid absorption stream, thereby obtaining a first gas effluent and a first liquid effluent,
c. increasing the pressure of the first gas effluent, to obtain a pressurized biogas stream,
d. feeding the pressurized biogas stream and a second liquid absorption stream to an absorber of the second absorption step,
e. absorbing carbon dioxide, and hydrogen sulphide if present, from the pressurized biogas stream into the second liquid absorption stream, thereby obtaining a second gas effluent and a second liquid effluent,
f. regenerating the first liquid effluent and the second liquid effluent in a regeneration system, thereby obtaining a regenerated absorption stream,
g. providing the regenerated absorption stream in two streams to obtain the first liquid absorption stream and the second liquid absorption stream, and
h. recovering or further processing the second gas effluent as an upgraded biogas stream.

This solution offers a biogas upgrade method providing a suitable carbon dioxide and hydrogen sulphide depletion with improved efficiency in terms of energy consumption. As gas compression and regeneration of absorbing liquid are energy intensive, providing acceptable gas purities while maintaining yields imposes a significant utility demand. The method according to the invention achieves increased energy efficiency, e.g. in the form of increased or similar purity of the upgraded biogas stream at substantially the same energy consumption or reduced energy consumption and capital cost while achieving the same purity levels and yields.

In some embodiments the biogas stream comprises hydrogen sulphide, the hydrogen sulphide, if present, being absorbed in steps b. and e. in addition to the carbon dioxide. The absorption is non-selective in the sense that if hydrogen sulphide is present it will also be absorbed under the conditions applied when carbon dioxide is absorbed.

In the method according to the invention the regenerated absorption stream is provided in two streams to obtain the first and second liquid streams. At the step where the first and second liquid absorption streams are provided from the regenerated absorption stream, they have the same composition. The absorption properties of the absorber of the second absorption step are altered compared to the absorber of the first absorption step by the increase in pressure. The increased pressure increases the partial pressures of carbon dioxide and hydrogen sulphide, if present, and thus promotes mass transfer in the absorber of the second absorption step. The increased absorption may thus be achieved without altering the liquid phase composition. This increased absorption achieved according to the method can also provide for lower levels of carbon dioxide and/or hydrogen sulphide in the upgraded biogas. It may also provide for a higher utilization or load of the absorbing streams, allowing for a reduced circulation rate of absorption liquid, lowering the energy consumption for regeneration. As part of the biogas stream is absorbed in the absorber of the first absorption step at lower pressure, the energy demand of pressurizing the first gas effluent will be reduced. The method may thus increase the purity of the second gas effluent by increasing the pressure in the absorber of the second absorption step compared to the absorber of the first absorption step, affecting the mass transfer from gas to liquid, rather than affecting e.g. the chemical driving force of the absorption by having a very pure absorption stream. This is especially advantageous in processes where regenerating the absorption streams to a high degree requires significantly more energy than regenerating them to a lesser degree, e.g. chemical absorption streams, such as amines.

Furthermore, in processes where the upgraded biogas is further processed, and the further processing requires compression, such as in the production of LBG, the energy consumption of the compression is advantageously also used in the biogas upgrade process to increase purity, thereby lowering the overall operational costs, rather than compressing only after the desired purity has been achieved.

In the method the biogas stream and the first liquid absorption stream are fed to the first absorber in a first absorption step, and the gas and liquid phases of the absorber of the first absorption step are brought into contact whereupon carbon dioxide and hydrogen sulphide, if present, is transferred from the gas to the liquid phase. The gas phase and liquid phase exiting the absorber of the first absorption step are herein denoted the first gas effluent and the first liquid effluent, respectively. The first liquid effluent is thus rich in carbon dioxide and hydrogen sulphide, if present, compared to the first liquid absorption stream and vice versa for the gas streams.

To further purify the first gas effluent, the pressure thereof is increased, and a second absorption step is carried out in the absorber of the second absorption step, at a higher pressure than in the absorber of the first absorption step. The gas phase and liquid phase exiting the absorber of the second absorption step are denoted the second gas effluent and the second liquid effluent respectively.

Hence, the first absorption step is performed at a lower pressure than the second absorption step. As will be explained in greater detail below, a greater part of carbon dioxide may be removed in the first absorption step at low pressure, than in the second absorption step, which second step may accordingly be termed a polishing step. Having a greater part of the carbon dioxide removed in the first step, reduces the amount of gas to be pressurized for the second step and thus lowers compressor duty.

The second gas effluent may be recovered as the upgraded biogas stream, which can optionally be further processed. Recovering is understood to be obtaining the upgraded biogas, and further processing could include further steps such as water removal, condensation or liquefaction.

The biogas stream may be provided directly from a biogas plant at low pressure and the absorber of the first absorption step may generally have an operating pressure corresponding to the pressure of the biogas stream. “Biogas plant” is understood to be a facility which produces the biogas from biomass. The pressure of the biogas stream is typically provided at about atmospheric pressure or slightly compressed, such as about 1 to 1.5 bara. The biogas may typically comprise 50-70% of methane, 30-50% carbon dioxide and up to 2% hydrogen sulphide on mole basis and may further contain water, oxygen and/or nitrogen if not pre-treated.

The pressurized biogas may be fed to a holding system, and gas retrieved from the holding system may then be fed to the absorber of the second absorption step as the pressurized biogas. A holding system as used herein is a system which stores or circulates gas, such as a holding tank or a gas grid. The gas fed to the holding system may be mixed with gas previously supplied from the absorber of the first absorption step or from other sources. This may allow for a variable production of upgraded biogas in case it is advantageous that only part of the biogas stream is upgraded to the quality of the second absorber. Alternatively, it could allow for feeding the pressurized biogas having grid level quality to a gas grid and retrieving pressurized gas from the gas grid, also at grid level quality, and feeding said retrieved biogas, as the pressurized biogas, to the absorber of the second absorption step, which may be commercially advantageous in some applications. This exchange with the holding system, e.g. gas grid, could also be done before pressurizing the first gas effluent, and then increasing the pressure of the retrieved biogas to provide the pressurized biogas stream.

The first and second liquid effluents are regenerated in the regeneration system to provide the regenerated absorption stream, which may be denoted a regeneration step. The regenerated absorption stream is the liquid(s) from which carbon dioxide and hydrogen sulphide, if present, has been removed in the regeneration step. The regenerated absorption stream is thus reused in the absorbers to deplete the biogas of carbon dioxide and hydrogen sulphide, if present, once again. The gas removed in the regeneration step may be denoted the off-gas which is a waste stream. The off-gas stream may contain methane, which is sometimes called a methane slip. As methane emissions are subject to increasing regulation and taxation, the off-gas is typically flared, thermally oxidized rather than being released to the atmosphere. In some cases, the hydrogen sulphide of the off-gas is led to a sulphur recovery plant. The regeneration step should not only be understood as feeding the liquid effluents directly to the regeneration system but may also encompass configurations where the liquid effluents are fed to other units or mixed into other streams prior to entering the regeneration system. In one such configuration the second liquid effluent is fed into the absorber of the first absorption step, preferably at the lower section of the absorber, thereby providing a mixed liquid phase in the absorber of the first absorption step which exits as the first liquid effluent which can then be regenerated in the regeneration system. In another configuration, the first and second liquid effluents are mixed outside of the absorbers of the first and second absorption steps, and the resulting mixture is regenerated in the regeneration system. In yet another alternative configuration, the first liquid effluent is fed to the absorber is fed to the second absorption step providing a mixed liquid phase therein which exits as the second liquid effluent which can then be regenerated in the regeneration system. Hence, the step of regenerating the first and second liquid effluents is understood to be a step of regenerating the liquid effluents of the first and second absorption steps regardless of the manner or composition in which they enter the regeneration system. The step could also be said to be a step of providing the regenerated absorption stream by regenerating the first liquid effluent and the second liquid effluent.

The term “regeneration system” should be understood to be a system which regenerates the liquid effluents to obtain the regenerated absorption stream. As such the regeneration system could comprise one or more regeneration units, such as one or more stripper columns, reboilers and/or flash units. In any such configuration it is contemplated that there is only one regenerated absorption stream which is used in the upgrade system.

Suitably, carbon dioxide removed from the first liquid effluent and second liquid effluent is contained in an off-gas of the regeneration system (R). Hence, the regeneration system is understood to contain the steps and unit operations from which carbon dioxide etc. is removed from the process. The off-gas of the regeneration system thus contains the gas which has been removed from the biogas stream to provide the upgraded biogas stream, and the regeneration system is where absorbed gas is removed from the overall process.

The regenerated absorption stream is provided in two streams to obtain the first liquid absorption stream and the second liquid absorption stream. This can be achieved by splitting the single regenerated absorption stream obtained from the regeneration system in two, or in a functionally equivalent manner where the regeneration system provides two streams of similar or equal composition. Hence, the first and the second liquid absorption streams are obtained from the same regenerated absorption stream. The second liquid absorption stream may be heated prior to feeding it to the absorber of the second absorption step. Any gas resulting from such heating may be recycled into the regeneration system as a stripping gas.

In a particular embodiment the first absorption step and the second absorption step are performed in one upgrade system, the first absorption step comprising steps a. and b., and the second absorption comprising steps c., d., and e, wherein the biogas stream is fed to the upgrade system, the regenerated absorption stream is fed to the upgrade system, the upgraded biogas is recovered from the upgrade system, and the first liquid effluent and second liquid effluent is fed from the upgrade system to the regeneration system. Thus, the upgrade system defines an operating unit having only two functionally distinct inlets, a feed gas inlet and a regenerated absorption steam inlet and two outlets, an upgraded biogas outlet and the rich absorption stream effluent outlet.

The upgrade system is thus separate from the regeneration system, and comprises the absorption steps, and, the streams which are exchanged between the upgrade system and regeneration system, are the rich absorption streams, i.e. first and second liquid effluents, and the regenerated absorption stream. The first and second liquid effluents may be retrieved separately or collectively from the upgrade system, for example they may be retrieved collectively after having been mixed in one of the absorbers of the first and second absorption steps.

Preferably, one liquid absorption stream is provided to the upgrade system, the one stream being the regenerated absorption stream.

In this way the regenerated absorption liquid used in all the absorption steps of the upgrade system come from the single regenerated absorption stream provided by the regeneration system. This configuration reduces the number of regeneration unit operations needed. The regenerated absorption stream may be provided to the upgrade system as one or more separate flows, while still being considered the only liquid absorption stream provided to the upgrade system. In performing the upgrade process there will typically be small losses of liquid absorption agent e.g. through the off-gas of the regeneration unit, and fresh absorption liquid will typically be added to counteract such losses. It is understood that such fresh liquid absorption agent can be added to the regeneration system or upgrade system without departing from the regenerated absorption stream being the one liquid absorption stream provided to the upgrade system.

Suitably, the upgrade system contains two absorption steps, the first and second absorption step.

Suitably, the method contains one upgrade system.

In a further development, the one upgrade system of the method contains two absorption steps, the first and second absorption step

Hence, the method and upgrade system does not have more than two absorption steps as understood herein, but it may contain additional steps which are not absorption steps, such as pressurizing steps or heating/cooling steps. In the context of the present invention an absorption step is understood as absorption at a specific operating pressure. One absorption step is thus distinct from another absorption step if the operating pressures are different, while two or more separate absorbers at the substantially the same operating pressure are understood to be one absorption step in the context of the invention.

Absorbers having substantially the same operating pressure may be absorbers where the pressure difference between them is only that caused by the operation of the absorber. For example, serially connected absorbers may have the same operating pressure if the pressure difference between the them is that caused by pressure drop over an absorber and the piping to the downstream absorber. Absorbers having substantially the same operating pressure may be absorbers, where the pressure difference is less than 1 bara.

Suitably, either or both of the first and second absorption steps is/are performed in two or more absorbers, the two or more absorbers of the first absorption step having substantially the same operating pressure and the two or more absorbers of the second absorption step having substantially the same operating pressure. In preferred embodiments each absorption step is performed in one absorber to obtain a simple system that provides the desired upgrade of the biogas.

In a further development, the upgrade system contains two absorption steps and one liquid absorption stream is provided to the upgrade system, namely the regeneration absorption stream. The first absorption step may be performed in multiple absorbers having the same operating pressure and/or the second absorption step may be performed in multiple absorbers having the same operating pressure.

Suitably the method further comprises a step of mixing the first and second liquid effluents. Mixing the first and second liquid effluent provides a stream of liquid which can be regenerated in a simple manner in the regeneration system to obtain the regenerated absorption streams. By “mixing” is understood that the two streams are combined, which can be achieved in several ways such as i) mixing the two streams outside of the first and absorber of the second absorption step, ii) feeding at least part of the second liquid effluent into the absorber of the first absorption step and thereby obtaining a mixed liquid phase which exits as the first liquid effluent or, iii) feeding the first liquid effluent to the absorber of the second absorption step providing a mixed liquid phase which exits as the second liquid effluent. In this configuration the first and second liquid effluents are mixed prior to the step of regenerating them.

Suitably the method further comprises a step of feeding at least a part of the second liquid effluent to the absorber of the first absorption step, preferably at a lower section of the absorber of the first absorption step.

By feeding the second liquid effluent into the absorber of the first absorption step, preferably at the lower section, the absorbed gasses of the second liquid effluent may be at least partially released, allowing them to be absorbed in the absorber of the first absorption step. This prevents methane absorbed in the absorber of the second absorption step at the higher pressure from being released in the regeneration system as only methane which remains absorbed at the lower pressure of the absorber of the first absorption step is led to the regeneration system, thereby reducing methane slip. By feeding the liquid effluent at the lower section of the absorber, the desorbed gas can be contacted with the liquid phase of the absorber. Lower section in this context should be understood to be below the midway point of the absorber, such as in the sump of the absorber. When the second liquid effluent is fed to the absorber of the first absorption step, the resulting liquid phase of the first absorption step, is the first liquid effluent.

By “at least a part of the second liquid effluent” should be understood that the entirety of the second liquid effluent could be fed to the absorber of the first absorption step or only a part thereof. This part could in one variation be gas desorbed from the second liquid effluent as a result of a pressure reduction such as in an intermediate flash unit. In such a case the desorbed gas is fed to the absorber of the first absorption step, while the remaining liquid could be added to the first liquid effluent outside of the absorber of the first absorption step. Such a step of flashing the second liquid effluent, is part of the upgrade system as the resulting gas is not removed from the overall process but recycled into the absorber of the first absorption step. The gases absorbed in the upgrade system are removed from the overall process in the regeneration system.

Suitably the method further comprises a step of feeding the first liquid effluent to the absorber of the second absorption step, preferably above a feeding point of the pressurized biogas stream, preferably at a midpoint of the absorber of the second absorption step.

Such a method may be advantageous in the case of chemical absorption, where the reaction kinetics are slow and the various partial pressures in the gas phase control the absorption. A higher pressure in an absorber provides a higher loading of the liquid phase, which reduces the required circulation rate of absorption liquid and in turn reduces the energy expenditure of regeneration. The term “load” is understood to be the amount of gas absorbed by the liquid compared to the maximum amount of gas it can absorb. However, compression of the biogas stream to such a pressure comes with significant compressor duty. By absorbing part of the carbon dioxide and hydrogen sulphide from the biogas stream into the first liquid effluent in the absorber of the first absorption step, the amount of gas to be compressed to the higher pressure is reduced. Further, as the resulting first liquid effluent is not fully loaded, it can be pressurized and fed to the absorber of the second absorption step, which will further increase the amount of absorbed gas therein before it is regenerated. In this way the amount of gas to be compressed is reduced and the required liquid circulation rate is reduced by increasing the load of the liquid phase overall, which improves the efficiency of the method. The first liquid effluent is not fed to the top of the absorber of the second absorption step as it is partially loaded with absorbed gas but at a position below the top of the absorber of the second absorption step, preferably at midway point of the absorber. The exact feeding position may vary depending on the composition of the first liquid effluent. In some embodiments, only part of the first liquid effluent is fed to the absorber of the second absorption step.

Suitably the operating pressure of the second absorption step is 4 to 70 bara, 4 to 40 bara or 6 to 40 bara, preferably 10 to 30 bara, more preferably 15 to 25 bara.

The specific pressure of the second absorption step is suitably chosen according to the requirements of the upgraded biogas and/or the type of absorption liquid. For chemical absorption, such as amine-based processes, a pressure of about 4 to 70 bara, or 4 to 40 bara may typically be suitable, such as 6 to 40 bara, 10 to 30 bara or 15 to 25 bar. It is within the skills of a practitioner to choose an appropriate pressure for a specific application and absorption agent within the range.

For chemical absorption agents, such as amines, lower pressures within the above ranges, will typically be used than for physical absorption agents, as the mass transfer is to a lesser degree dependent on solubility and increased pressures may also entail higher methane slip. Hence, 4 to 40 bara, 10 to 30 or 15 to 25 bara may be suitable.

Unless otherwise specified, the operating pressure of an absorber or absorption step should be understood to be the pressure of the gas effluent thereof. Unless otherwise specified, pressure values provided herein are absolute pressures.

Suitably the method further comprises a step of increasing the pressure of the second liquid absorption stream. The pressure of the second liquid absorption stream is suitably increased to at least the operating pressure of the second absorption step. The flow rate of the second liquid absorption stream is typically much lower than that of the first liquid absorption stream, the utility costs associated with increasing the pressure of the second liquid effluent may be negligible.

Suitably the operating pressure of the first absorption step is 0.7 to 6 bara, 1 to 6 bara, 1 to 4 bar, preferably 1 to 2 bar, more preferably 1 to 1.5 bar.

Typically, the operating pressure of the first absorption step is at substantially the level as the pressure of the supplied biogas, which may be obtained directly from the biogas plant. The pressure of the first absorption step may be higher than the supplied biogas as may be required for practically feeding the gas and liquid by way of blowers and pumps to the absorber of the first absorption step. If the operating pressure of the absorber of the first absorption step is 4 bar, the operating pressure of the absorber of the second absorption step is greater than 4 bar, but still within the pressure range as defined herein for the operating pressure of the absorber of the second absorption step.

Suitably step f. comprises heating the first liquid effluent and the second liquid effluent, to obtain the regenerated absorption stream.

Heating the liquid effluents release the absorbed gas, thus regenerating the liquid effluents into the regenerated absorption stream. In a similar manner to the step of regeneration, heating the first and second liquid effluents should not only be understood as the direct heating of the two effluents, but also contemplates configurations where the liquid effluents are mixed within or outside of the absorbers, and the combined effluents are heated. Regeneration by heating may allow for a higher degree of regeneration compared to other methods such as a flash separation. Degree of regeneration is understood to be the amount of absorbed gasses released from the liquid compared to fully desorbed liquid. Heating may be combined with a pressure reduction. Regeneration by heating is particularly suitable for regenerating chemical absorption streams.

Suitably the regeneration system comprises a stripper column with a reboiler.

In a regeneration system which comprises a stripper column with reboiler, the liquid is heated by the reboiler thereby generating a vapour stream at the bottom of the column. The vapour stream flows upward through the column and contacts the influent liquid to strip off absorbed carbon dioxide and/or hydrogen sulphide. The gas effluent of the stripper column may be denoted an off-gas, this off-gas can be cooled to condensate some of the gas effluent and/or treated with water to recover any absorption agent contained in the gas effluent of the stripper column. Recovered liquid may be recycled into the stripper column or alternatively into one of the absorbers. There could be more than one stripper column with a reboiler, where the liquid effluents of said stripper columns are combined to obtain the regenerated absorption stream. Such a regeneration system is particularly suitable for regenerating chemical absorption streams.

Suitably the regeneration system is one single regeneration unit in which both the first and second liquid effluents are regenerated to provide the regenerated absorption stream, preferably wherein the regeneration unit is a stripper column with a reboiler.

A single regeneration unit may be economically advantageous. A regeneration system having one single stripper with a reboiler may similarly be economically advantageous. The liquid effluents of the first and the second absorption steps are regenerated in a single regeneration unit, preferably the stripper with a reboiler, providing the regenerated absorption stream. A stripper with a reboiler is particularly suitable for regenerating chemical absorption streams. The regeneration unit may in addition to the stripper with a reboiler, comprise means for recovering absorption agent from the gas effluent of the stripper, also denoted off-gas, in order to recycle the recovered liquid into the stripper column or alternatively into one of the absorbers of the upgrade system. Such means for recovering could be a cooler which condenses part of the gas effluent into liquid, followed by a gas-liquid separator.

Suitably, the single regeneration unit provides the regenerated absorption stream as the only absorption liquid provided to the upgrade system, preferably one upgrade system.

Suitably, the amount of carbon dioxide absorbed in step b. into the first liquid absorption stream is greater than the amount of carbon dioxide absorbed in step e. into the second liquid absorption stream.

In this way less first gas effluent will need pressurisation for the second absorption step. This can be achieved by configuring the flow rate of the first liquid absorption stream to being greater than the flow rate of second liquid absorption stream. This may also be expressed as the gas-liquid ratio of the first absorption step being smaller than the gas-liquid ratio of the second absorption step, whereby the first absorption step will have more liquid in relation to gas than the second absorption step.

The absorber heights also affect the amount of carbon dioxide removed, and as is known to the skilled person, they are selected according to the selected gas-liquid ratio and equilibria considerations. In the context of the invention, the absorber heights are selected to achieve the contact time between gas and liquid such that the gas and liquid phase at the bottom of the absorber is substantially in equilibrium with respect to carbon dioxide.

Suitably, a total flow is the sum of the flow rates of the first and second liquid absorption streams, and the flow rate of the second liquid absorption stream is 1 to 30% the total flow rate, such as 1 to 25%, 1 to 20%, 2 to 15%, 3 to 15%, 3 to 12%.

In this way, a larger part the regenerated absorption stream is used in the first absorption step and the majority of carbon dioxide (and therefore also any hydrogen sulphide if present) is removed in the first absorption step.

Suitably, a ratio of the flow rate of biogas stream and the flow rate of the first liquid absorption stream, abbreviated GL1, is less than a ratio of the flow rate of first gas effluent and the flow of rate of the second liquid absorption stream, abbreviated GL2.

GL1 and GL2 are the gas-liquid ratios of the absorption steps and may suitably be expressed as a molar flow rate fractions.

When GL1 is less than GL2, more liquid is used per unit gas in the first absorption step, whereby the first absorption step will remove more carbon dioxide than the second absorption step.

Suitably, GL1 is less than 20% (0.2), less than 10% (0.1), suitably 1 to 20% (0.01 to 0.2), 2 to 15% (0.02 to 0.15), 2 to 10% (0.02 to 0.1) or 4 to 8% (0.04 to 0.08).

Suitably, GL2 is greater than 20% (0.2) or greater than 30% (0.3), suitably in the range of 20 to 150% (0.2 to 1.5), 20 to 40% (0.2. to 0.4), 25 to 35% (0.25 to 0.35).

Suitably the first and second liquid absorption streams are chemical absorption streams.

Chemical absorption streams comprise a chemical absorption agent, whereby the method makes use of chemical absorption, which is sometimes referred to as reactive absorption, to remove gas components from the biogas stream. The method according to the invention may be especially advantageous for chemical absorption processes. Chemical absorption streams are typically regenerated using heat in the regeneration units as described above. The regeneration of chemical absorption streams can involve high heating duties to release the absorbed gas, especially to obtain a high degree of regeneration. As chemical absorption is controlled by the concentration of available reactant, obtaining low carbon dioxide and/or hydrogen sulphide levels (emission levels) in the upgraded biogas using chemical absorption can require prohibitive amounts of energy. By having a second absorption step operating at a higher pressure, the method according to the invention allows for achieving lower emission levels at the same degree of regeneration of the absorption stream. The pressure increase of the absorber of the second absorption step may be especially advantageous compared to increased heating duty in some applications, depending on the available hot streams and/or need for pressurization in further processing of the upgraded biogas.

The chemical absorption agent may be any suitable chemical absorption agent used in the art such as but not limited to commercially available alkanolamines. A suitable alkanolamine may be selected from the group consisting of monoethanolamine, diethanolamine, diisopropanolamine, methyldiethanolamine and triethanolamine. Another suitable amine is piperazine. Typically, the chemical absorption stream is an aqueous solution of one of the above-mentioned amines. However, mixtures comprising promoters, such as vanadium, and one or more of the listed amines in any mixing ratio may also be used in the method according to the invention. It is within the skills of a practitioner to determine the optimal amount and composition of the absorbing agent in order to achieve a suitable absorption procedure.

Suitably the first and second liquid absorption streams are physical absorption streams.

Physical absorption streams are to be understood as absorption streams that do not contain chemical absorption agents, and thus rely on physical absorption. The physical absorption streams may be any suitable physical absorption stream used in the art such as but not limited to water, methanol, NMP or mixtures of dimethyl ethers of polyethylene glycol, such as the commercially available Seloxol™ or Genosorb®. The regeneration of physical absorption agents is typically performed in a stripper column with a stripping gas, where heating is not necessary. Mass transfer in physical absorption agents is to large extent determined by the solubility of the gasses in the liquid phase and hence the operating pressures of the absorption steps, when using physical absorption, are typically high. Suitably, the operating pressures of the first absorption step would be 4 to 6 bara and the second absorption step 6 to 70 bara or 6 to 40 bara.

Preferably a single regenerated absorption stream is obtained in step f

The first and second liquid absorption streams are thus respective portions of the single regenerated absorption stream.

Suitably the method further comprises a step of removing water from the second gas effluent, thereby obtaining a dried biogas stream, and a step of recovering or further processing the dried biogas stream as the upgraded biogas stream. The second gas effluent may contain some water which can be removed to provide a dried biogas stream. Water removal could be achieved by pressure-swing-adsorption or temperature-swing-adsorption or other procedures which are known to the skilled practitioner.

Suitably the upgraded biogas stream comprises less than 50 ppm carbon dioxide and less than 4 ppm hydrogen sulphide on dry basis. “On dry basis” is understood to be the content of a species expressed as fraction/percentage of the total, where water is disregarded from the total.

The method may provide upgraded biogas having such emission levels, at improved energy/utility cost. These emission levels can be required in some applications such as for the production LBG.

Suitably the upgraded biogas stream is further processed into liquified biogas (LBG).

Lower levels of carbon dioxide and hydrogen sulphide are required for producing LBG compared to e.g. grid quality biogas, as carbon dioxide will condense and solidify during liquefaction of the biogas, potentially clogging the systems, and hydrogen sulphide may entail corrosion issues. The method according to the invention provides the upgraded biogas stream at increased pressure, and this increased pressure can be used in the liquefaction process to reduce the temperature by expansion. Hence, the energy expenditure of increasing the pressure in the absorber of the second absorption step to drive absorption, can be recovered at least in part in the liquefaction process. The method may thus have a synergistic effect in production of LBG. Processes for gas liquefaction are known to the skilled practitioner.

A biogas upgrade system for upgrading a biogas stream is also provided, the system being configured for performing a method according to the invention.

### DETAILED DESCRIPTION

In the following, the invention is described with reference to the non-limiting examples and drawings, where

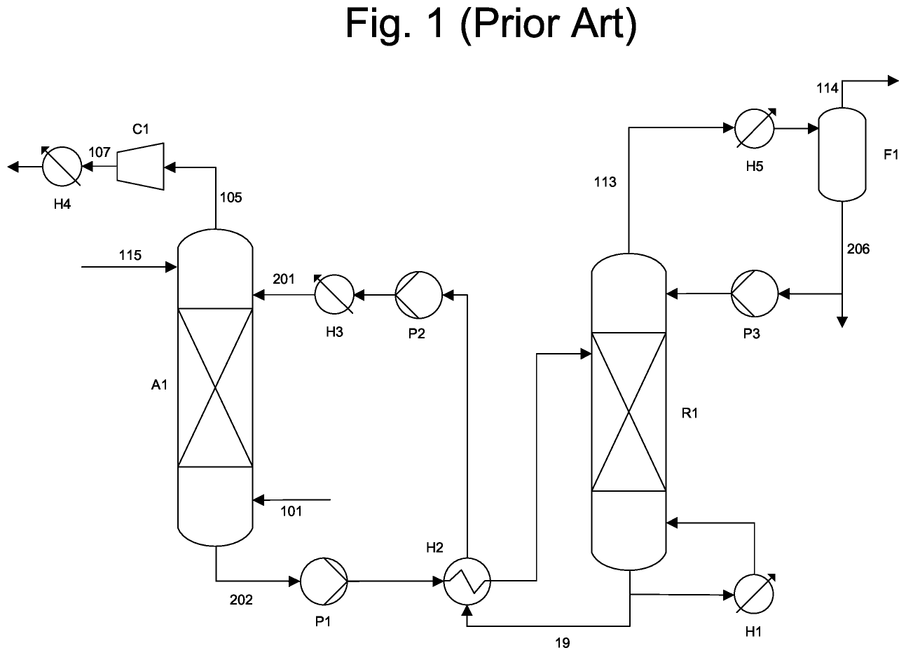

FIG. 1 shows a schematic diagram of biogas upgrade plant known in the art,

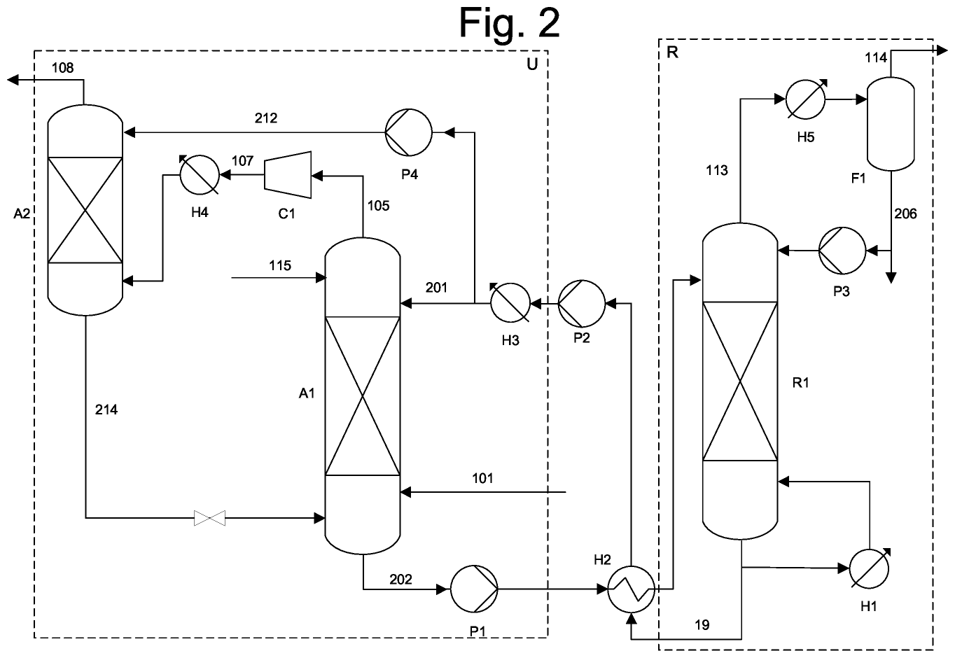

FIG. 2 shows a schematic diagram of an embodiment of the invention where the second liquid effluent is fed to the absorber of the first absorption step,

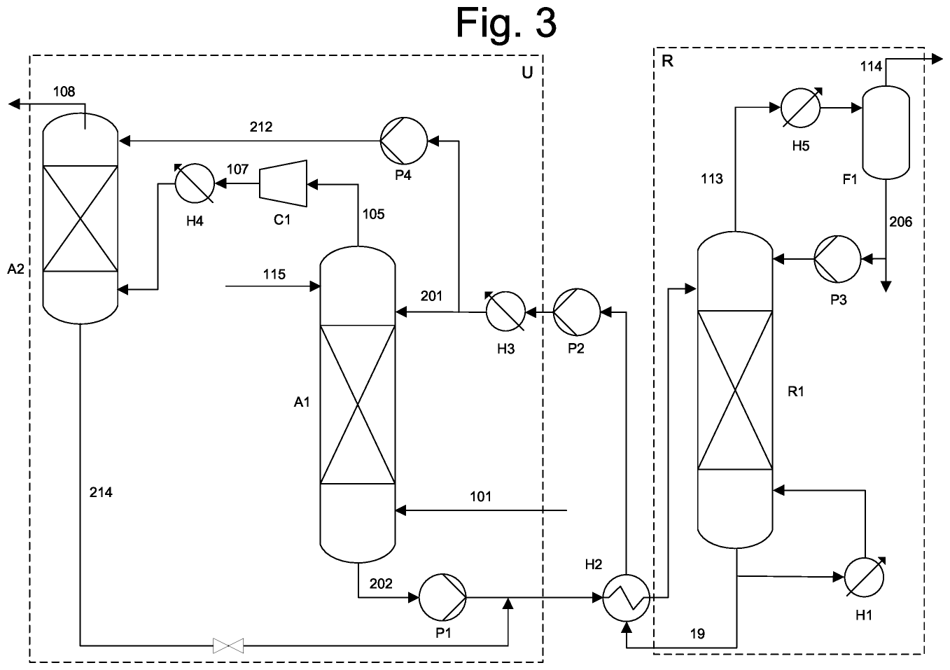

FIG. 3 shows a schematic diagram of an embodiment of the invention where the first and second liquid effluents are mixed prior to regeneration,

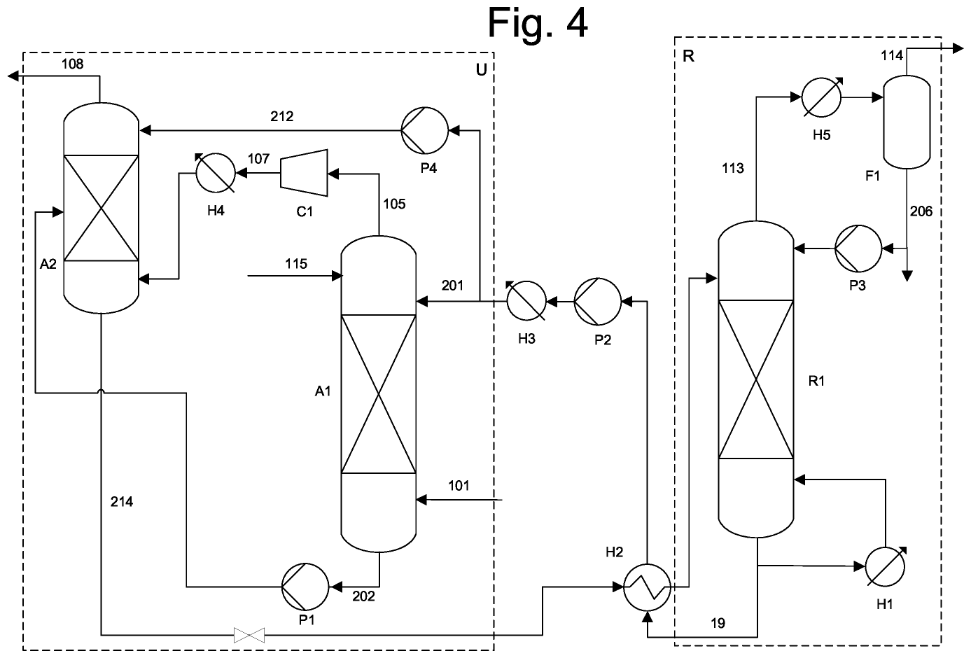

FIG. 4 shows a schematic diagram of an embodiment of the invention where the first liquid effluent is fed into the absorber of the second absorption step,

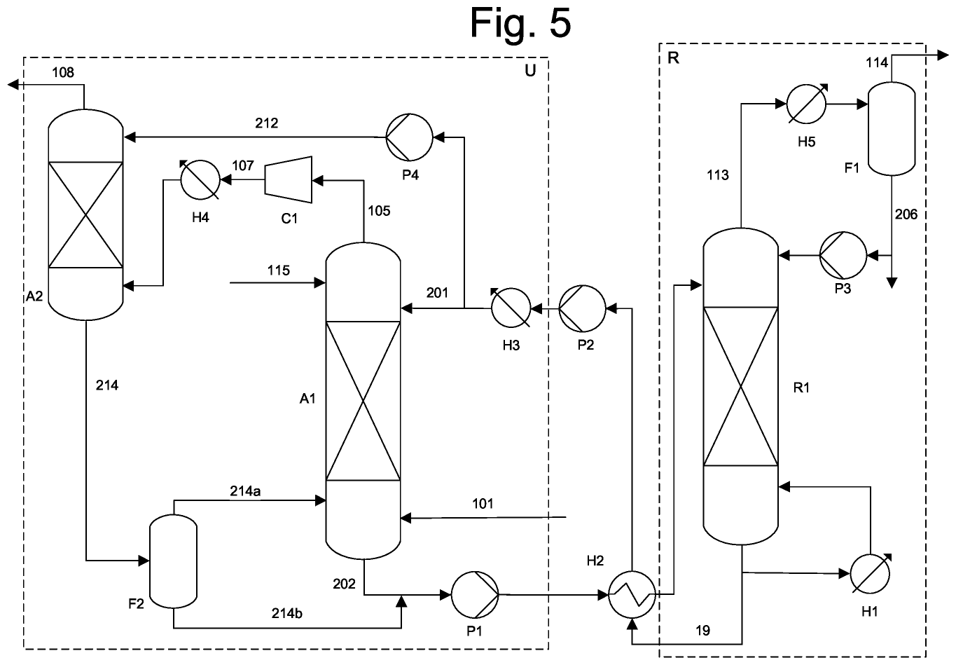

FIG. 5 shows a schematic diagram of an embodiment of the invention where a part of the second liquid effluent is fed to the absorber of the first absorption step, and

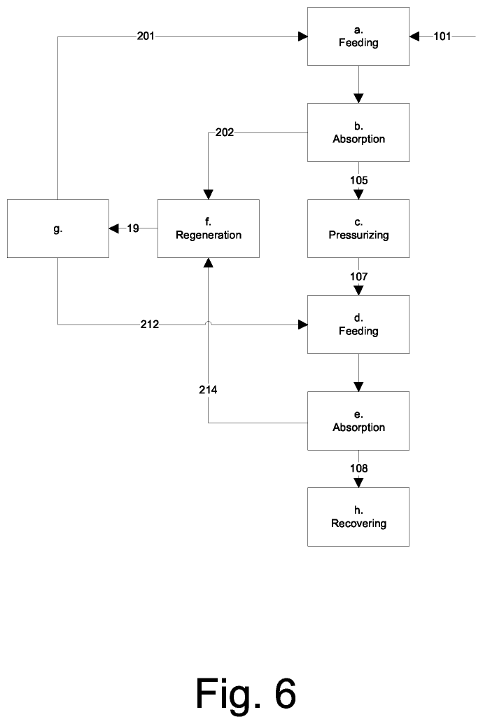

FIG. 6 shows a schematic illustration of the concept of the invention.

FIG. 1 shows a diagram of a process known in the art for upgrading biogas. Biogas comprising methane, carbon dioxide, and hydrogen sulphide, which is to be upgraded, is fed to the process as biogas stream 101. Biogas stream 101 is fed at the bottom of the absorber A1 where it is contacted counter-currently with a chemical absorption liquid which is fed at the top of the absorber A1 as the first liquid absorption stream 201. The gas phase exits the first absorber as first gas effluent 105 which has a reduced content of carbon dioxide and/or hydrogen sulphide compared to the biogas stream 101. The pressure of the first gas effluent 105 is increased in compressor C1 and recovered as the upgraded biogas stream which can be further processed or supplied to a gas grid. The pressurization is necessary for supplying the upgraded biogas to a gas grid or for further processing steps. The liquid phase exits the absorber A1 as the first liquid effluent 202, which is pumped to regeneration unit R1, a stripper with a reboiler. In the regeneration unit R1 the first liquid effluent 202 is heated by way of heater H1 (the reboiler) to release absorbed gas and regenerate the chemical absorption liquid, thereby providing the regenerated absorption stream 19. The regenerated absorption stream 19 is recycled into absorber A1 as the first liquid absorption stream 201. The gases which are desorbed or vaporized in the regeneration unit R1 exits as off-gas 113 which is processed in heat exchanger H5 and separator F1 to recycle condensed liquid 206 into the regeneration unit R1 and yielding the waste off-gas 114. Fresh chemical absorption liquid or make-up liquid, such as water, may be supplied to the first absorber as stream 115 to counter-act loss of liquid in the system and/or to absorb any absorption agent from the gas phase. Moreover, stripping gas (not shown) could be fed to the regeneration unit R1 to increase the mass transfer. In variations where the process is performed with a physical absorption liquid, such as water or methanol, a typical regeneration unit would comprise a stripper column to which a stripping gas is supplied to the system. As shown in FIG. 1 the process includes several heat exchangers H2, H3, H4, H5 for heating or cooling the streams, and, pumps P1, P2, P3 for circulating the streams. Heat exchanger H1 is provided to preheat first liquid effluent 202 with the excess heat of the regenerated absorption stream 19. The symbols used in the diagram are the typical representations used in the art and do not confer any information as to the nature of the equipment used beyond the type of unit operation.

FIG. 2 shows a diagram of an embodiment of the method according the invention. Unless otherwise stated the features and reference numbers are similar to those of FIG. 1. In the embodiment shown, the upgrade system (U) comprise one absorber in each of the first and second absorptions steps. The biogas stream 101 is fed to the bottom of the first absorber A1 while the first liquid absorption stream 201 is fed to the top. The resulting gas phase exits as the first gas effluent 105 which has a reduced content of carbon dioxide and/or hydrogen sulphide. The pressure of the first gas effluent 105 is increased in compressor C1, thereby obtaining the pressurized biogas stream 107 which is fed to the second absorber A2. The pressure of the pressurized biogas stream 107 is at least at the level of the operating pressure of the second absorber A2. The second liquid absorption stream 212 is fed at the top of the second absorber after having been pressurized by pump P4 to at least the operating pressure of the second absorber A2. In the second absorber A2, further carbon dioxide and/or hydrogen sulphide is absorbed from the gas phase, whereby the second gas effluent 108 and the second liquid effluent 214 are obtained. The first liquid effluent 202 and second liquid effluent 214 are regenerated in the regeneration system R thereby providing the regenerated absorption stream 19. The upgrade system U is indicated by dashed line and contains the absorber A1 of the first absorption step and the absorber of the second absorption step A2. The biogas stream 101 and regenerated absorption stream 19 are provided to the upgrade system U, while the upgraded biogas stream 108 and first liquid effluent 202 containing part of the second liquid effluent 214 are collected from the upgrade system U. The regeneration system R is indicated by a dashed line and contains a single regeneration unit R1 which regenerates the influent liquid by heating through heater H1 similar to the prior art process illustrated in FIG. 1. The condensed liquid stream 206 could in alternative configurations be added to stream 19 or fed to the top of one of the absorbers in place of or in addition to stream 115, in order to absorb any chemical absorption agent from the gas phase prior to the gas exiting the absorber. The regenerated absorption stream 19 is provided in two streams by splitting the regenerated absorption stream 19 to obtain the first liquid absorption stream 201 and second liquid absorption stream 212. As the first and second liquid absorption streams 201, 212 are provided from the regenerated absorption stream 19 they have the same composition. Prior to regeneration, the second liquid effluent 214 is mixed with the first liquid effluent 202 by feeding the second liquid effluent 214 to the first absorber A1, whereby the liquid from the second liquid effluent 214 is admixed with the first liquid effluent 202, both constituting the first liquid effluent 202, which is then pumped to the regeneration system R by pump P1. This recycling of the second liquid effluent 214 allows gas absorbed in the second liquid effluent 214 to be released by the reduced pressure in the first absorber A1, and subsequently to be absorbed in the first absorber. In this way, any methane absorbed in the absorber of the second absorption step A2 due to the increased pressure, is released into the gas phase of the first absorber A1 whereby the methane slip of the liquid effluents is reduced. In FIG. 2 a valve is provided for reducing the pressure of the second liquid effluent 214. The streams which are exchanged between the upgrade system U and regeneration system R are the first liquid effluent 202, containing the second liquid effluent 214, and the regenerated absorption stream 19. The regenerated absorption stream 19 is the only liquid absorption stream provided to the upgrade system U, the make-up stream 115 serving to counteract liquid loss in the process could also have been added to the regenerated absorption stream 19.

FIG. 3 shows a diagram of another embodiment of the method according the invention. Unless otherwise stated the features and reference numbers are similar to those of FIG. 2. In FIG. 3 the second liquid effluent 214 is mixed with the first liquid effluent 202 outside of the absorbers A1 and A2 and the resulting mixture is fed to the regeneration system R. In an alternative configuration the first liquid effluent 214 and second liquid effluent 202 are mixed in the regeneration unit R1 (not shown), and in yet another alternative, each liquid effluent is regenerated in separate regeneration units of the regeneration system, and the resulting liquid effluents are combined to obtain the regenerated absorption stream 19 (not shown)

FIG. 4 shows a diagram of another embodiment of the method according the invention. Unless otherwise stated the features and reference numbers are similar to those of FIG. 2. In FIG. 4 the first liquid effluent 202 and second liquid effluent 214 are mixed prior to regeneration by feeding the first liquid effluent 202 to the absorber of the second absorption step A2. A part of the biogas stream 101 is absorbed in the first absorber A1 thereby reducing the amount of gas to be compressed in compressor C1. The first liquid effluent 202 is pressurized by way of pump P1 and fed to the absorber of the second absorption step A2 at the midpoint of the absorber. By this configuration further gas is absorbed therein to increase the load of the liquid absorption stream before it is regenerated, thereby reducing the required circulation rate of liquid.

FIG. 5 shows a diagram of another embodiment of the method according the invention. Unless otherwise stated the features and reference numbers are similar to those of FIG. 2. In FIG. 5, a part of the second liquid effluent 214 is recycled into the first absorber. The recycled part is generated by flash separating the second liquid effluent 214 in separator F2 to provide a gas part 214a and a liquid part 214b thereof, allowing for the gas part 214a to be recycled into the first absorber A1 while mixing the liquid part 214b into the first liquid effluent 202. The separator F2 is not part of the regeneration system (R) as any carbon dioxide removed from the second liquid effluent 214 in separator F2 is not removed from the overall process but recycled into absorber A1. The off-gas 113 contains the carbon dioxide removed from the process.

FIG. 6 shows a schematic presentation of the steps of a method according to invention, thus illustrating the concept thereof. In step a. the biogas stream 101 and the first liquid absorption stream 201 are fed to the absorber A1 of the first absorption step. In step b. the gas and liquid phases in the first absorption step are brought into contact, whereby carbon dioxide and hydrogen sulphide are absorbed from the gas phase into the liquid phase. The liquid phase exits as the first liquid effluent 202 and the gas phase as the first gas effluent 105. The first gas effluent 105 is pressurized in step c. providing a pressurized biogas stream which in step d. is fed to the absorber A2 of the second absorption step along with the second liquid absorption stream 212. Carbon dioxide and hydrogen sulphide are absorbed from the gas phase into the liquid phase which in turn exit as the second liquid effluent 214 and second gas effluent 108 respectively. The second gas effluent 108 is recovered or further processed in step h. as the upgraded biogas. The first liquid effluent 202 and second liquid effluent 214 are regenerated in step f providing the regenerated absorption stream 19, which in step g. is provided in two streams as the first liquid absorption stream 201 and second liquid absorption stream 212. As regards step f it is to be understood that the conceptual illustration of FIG. 6 does not show how the first and second liquid effluents may be routed in a processing plant which employs the method of the invention.

The advantages of the invention will now be illustrated by way of the following non-limiting examples. The examples are process simulations performed in commercially available software such as CHEMCAD.

### EXAMPLE I

### Comparative

A biogas stream is upgraded according to a process as exemplified in FIG. 1. Stream properties and compositions as well as utility duties are as shown in Table I, where the reference numbers are those of FIG. 1. The absorption agent is monoethanolamine (MEA) and the absorber has a column height of 16 m. The absorber is in equilibrium, i.e. further column height would not improve the upgrade process. The upgraded biogas contains 95.11 mole % methane and 274.7 ppm carbon dioxide and 81.7 ppm hydrogen sulphide. On dry basis, this corresponds to 99.96 mole % methane, 288.7 ppm carbon dioxide and 85.8 ppm hydrogen sulphide.

TABLE I

| | | Lean | Waste | Upgraded | Pressurized |
|---|---|---|---|---|---|
| Name | Biogas | amine | Off-gas | Biogas | Biogas |
| Reference | 101 | 201 | 114 | 105 | 107 |

Stream Properties

| | | | | | |
|---|---|---|---|---|---|
| Temperature | 35 | 35 | 50 | 34.92 | 40 |
| C. ° | | | | | |
| Pressure | 1.1 | 4.5 | 1.8 | 1.1 | 11 |
| bar(a) | | | | | |
| Mass flow | 1261.25 | 19197.68 | 816.30 | 449.82 | 449.82 |
| kg/h | | | | | |

Stream Composition mole %

| | | | | | |
|---|---|---|---|---|---|
| Methane | 56.37 | 0 | 0.04715 | 95.11 | 95.11 |
| Carbon | 37.58 | 3.404 | 90.83 | 0.02747 | 0.02747 |
| dioxide | | | | | |
| Hydrogen | 0.9394 | 0.01456 | 2.259 | 0.008166 | 0.008166 |
| sulphide | | | | | |
| Water | 5.117 | 85.68 | 6.861 | 4.850 | 4.850 |
| MEA | — | 10.90 | 0 | 0.000254 | 0.000254 |

Utility Duties kW

| | |
|---|---|
| Compressor C1 | 78.7 |
| Heat Exchanger H1 | 750 |

### EXAMPLE II

The feed biogas of Example I is in this example upgraded according to a process as exemplified in FIG. 2, i.e. according to an embodiment of the invention. Stream properties and compositions as well as utility duties are as shown in Table II, where the reference numbers are those of FIG. 2. The absorption agent is monoethanolamine (MEA) and the absorber of the first absorption step has a column height of 12 m and the absorber of the second absorption step has a height of 4 m. The upgraded biogas contains 99.47 mole % methane and 41.4 ppm carbon dioxide and 11.1 ppm hydrogen sulphide, which on dry basis is 99.99 mole %, 41.6 ppm and 11.2 ppm respectively.

The waste off-gas contains 394 ppm methane (methane slip).

The molar gas-liquid ratio of the absorber of the first absorption step, GL1, is about 0.06 (6%) and GL2 in the absorber of the second absorption step it is about 0.33 (33%).

Compared to example I, the present example has the same heating duty in heater H1 of 750 kW, practically the same compressor duty of about 79 kW, and the total absorber column height of the two examples are equivalent. As can be seen example II provides a purer upgraded biogas at practically the same utility duty and is thus more efficient. Further, the methane slip in the off-gas is also reduced compared to example I. The added pump duty associated with the second liquid absorption stream is insignificant due to the comparatively low utility demand of liquid pumps. The example is not necessarily optimized.

TABLE II

| | | 1^{st} Lean | First gas | Pressurized | 2^{nd} Lean | Upgraded | Waste |
|---|---|---|---|---|---|---|---|
| Name | Biogas | amine | effluent | biogas | amine | biogas | Off-gas |
| Reference | 101 | 201 | 105 | 107 | 212 | 108 | 114 |

Stream Properties

| | | | | | | | |
|---|---|---|---|---|---|---|---|
| Temperature C. ° | 35 | 35 | 34.97 | 40 | 35.27 | 35.6 | 50 |
| Pressure bar(a) | 1.1 | 4.5 | 1.1 | 11 | 22 | 11 | 1.8 |
| Mass flow kg/h | 1261.25 | 17210 | 450.6 | 450.6 | 2000 | 427.7 | 817.1 |

Stream Composition mole %

| | | | | | | | |
|---|---|---|---|---|---|---|---|
| Methane | 56.37 | 0 | 95.05 | 95.05 | 0 | 99.47 | 0.03968 |
| Carbon dioxide | 37.58 | 3.672 | 0.3684 | 0.3684 | 3.672 | 0.004136 | 90.84 |
| Hydrogen sulphide | 0.9394 | 0.01660 | 0.01064 | 0.01064 | 0.01660 | 0.001115 | 2.262 |
| Water | 5.117 | 85.13 | 4.905 | 4.905 | 85.13 | 0.5275 | 6.862 |
| MEA | — | 11.17 | 0.000257 | 0.000257 | 11.18 | 0.000413 | 0 |

Utility Duties kW

| | |
|---|---|
| Compressor C1 | 78.8 |
| Heater H1 | 750 |

### EXAMPLE III

A biogas stream is upgraded according to a process as exemplified in FIG. 2 to achieve low emissions of carbon dioxide or hydrogen sulphide. Stream properties and compositions are as shown in Table II, where the reference numbers are those of FIG. 2. The absorption agent is methyldiethanolamine (MDEA). The upgraded biogas contains 98.68 mole % methane and 1.6 ppm carbon dioxide and 0 ppm hydrogen sulphide. On dry basis, this corresponds to 98.98 mole % methane, 1.6 ppm carbon dioxide and 0 ppm hydrogen sulphide.

The molar gas-liquid ratio of the first absorption step, GL1, is about 0.08 (8%) and in the second absorption step it, GL2, is about 1.35 (135%).

TABLE III

| | | 1^{st} Lean | First gas | Pressurized | 2^{nd} Lean | Upgraded | |
|---|---|---|---|---|---|---|---|
| Name | Biogas | amine | effluent | biogas | amine | biogas | Off-gas |
| Reference | 101 | 201 | 105 | 107 | 212 | 108 | 113 |

Stream Properties

| | | | | | | | |
|---|---|---|---|---|---|---|---|
| Temperature C. ° | 40 | 40 | 39.8 | 35 | 40.2 | 40.1 | 98.3 |
| Pressure bar(a) | 1.35 | 4.5 | 1.35 | 21.5 | 22 | 21.5 | 1.5 |
| Mass flow kg/h | 3242.5 | 41932.7 | 1131.7 | 1137.9 | 1500 | 1113.4 | 3017.0 |

Stream Composition mole %

| | | | | | | | |
|---|---|---|---|---|---|---|---|
| Methane | 53.92 | 0 | 93.49 | 96.98 | 0 | 98.68 | 0.019 |
| Carbon dioxide | 38.35 | 0.046 | 0.13 | 0.13 | 0.046 | 0.00016 | 45.58 |
| Hydrogen sulphide | 0.020 | 0.000007 | 0.00005 | 0.00005 | 0.000007 | 0 | 0.00008 |
| Oxygen | 0.18 | 0 | 0.32 | 0.33 | 0 | 0.33 | 0.000048 |
| Nitrogen | 0.37 | 0 | 0.63 | 0.66 | 0 | 0.67 | 0.000033 |
| Water | 7.25 | 89.07 | 5.42 | 1.90 | 89.07 | 0.31 | 54.38 |
| MDEA | 0 | 10.89 | 0 | 0 | 10.89 | 0.000022 | 0.019 |

### EXAMPLE IV

A biogas stream is upgraded according to a process as exemplified in FIG. 4, wherein the first liquid effluent 202 is pressurized to 8 bar(a) and fed to the middle of absorber A2. The second liquid effluent 214 is withdrawn at 8 bar(a) from the absorber of the second absorption step A2. The absorption agent in this example is commercially available MDEA based product sold under the name AdapT 201. Stream properties and compositions are as shown in Table IV, where the reference numbers are those of FIG. 4.

TABLE IV

| | | 1^{st} Lean | First gas | Pressurized | 2^{nd} Lean | Upgraded |
|---|---|---|---|---|---|---|
| Name | Biogas | amine | effluent | biogas | amine | biogas |
| Reference | 101 | 201 | 105 | 107 | 212 | 108 |

Stream Properties

| | | | | | | |
|---|---|---|---|---|---|---|
| Temperature C. ° | 40 | 60 | 30 | 215.8 | 60.1 | 30 |
| Pressure bar(a) | 1.10 | 1.2 | 1.06 | 6.0 | 15.0 | 7.99 |
| Mass flow kg/h | 3122.5 | 26108.1 | 2432.6 | 2432.6 | 6228.4 | 1185.6 |

Stream Composition mole %

| | | | | | | |
|---|---|---|---|---|---|---|
| Methane | 57.4 | 0.00 | 66.5 | 66.5 | 0.00 | 95.7 |
| Carbon dioxide | 38.2 | 2.16 | 29.0 | 29.0 | 2.16 | 3.77 |
| Hydrogen sulphide | 0.596 | 0.0375 | 0.522 | 0.522 | 0.0375 | 0.052 |
| Water | 3.82 | 85.9 | 4.03 | 4.03 | 85.9 | 0.549 |
| Adapt 201 | — | 11.894 | 0.00 | 0.00 | 11.894 | 0.00 |

### EXAMPLE V

In this example the biogas of Example II is upgraded according to a process as exemplified in FIG. 3 at the conditions used in Example II. Stream properties and compositions as well as utility duties are as shown in Table V, where the reference numbers are those of FIG. 3. The absorption agent is monoethanolamine (MEA) and the absorber of the first absorption step has a column height of 12 m and the absorber of the second absorption step has a column height of 4 m. The upgraded biogas contains 99.47 mole % methane and 40.8 ppm carbon dioxide and 11.0 ppm hydrogen sulphide, which on dry basis is 99.99 mole %, 41.0 ppm and 11.1 ppm respectively. The composition of the upgraded biogas is thus substantially equal to that of Example II.

The methane slip in the waste off-gas which in this example is 1161 ppm. In example II, the methane slip was 394 ppm. The reduced methane slip in in Example II compared to this example is provided by recycling the second liquid effluent to the absorber of the first absorption step, and the methane not found in the waste-gas of Example II, is found in the upgraded biogas.

Hence, the configuration of FIG. 2 improves both methane production and reduces methane slip by recycling the second liquid effluent into the first absorption step. This is advantageous in two ways as it increases biomethane production and reduces methane slip, which is an emission subject to increasingly strict regulation and taxes.

The molar gas-liquid ratio of the first absorber is about 0.07 (7%) and in the second absorption step it is about 0.36 (36%).

The example above may be further optimized to increase the resulting effect shown here. This is within the skill of the skilled practitioner.

TABLE V

| | | 1^{st} Lean | First gas | Pressurized | 2^{nd} Lean | Upgraded | Waste |
|---|---|---|---|---|---|---|---|
| Name | Biogas | amine | effluent | biogas | amine | biogas | Off-gas |
| Reference | 101 | 201 | 105 | 107 | 212 | 108 | 114 |

Stream Properties

| | | | | | | | |
|---|---|---|---|---|---|---|---|
| Temperature C. ° | 35 | 35 | 48.70 | 40 | 35.27 | 35.6 | 50 |
| Pressure bar(a) | 1.1 | 4.5 | 1.1 | 11 | 22 | 11 | 1.8 |
| Mass flow kg/h | 1261.25 | 17134 | 495.5 | 495.5 | 2000 | 427.7 | 816.9 |

Stream Composition mole %

| | | | | | | | |
|---|---|---|---|---|---|---|---|
| Methane | 56.37 | 0 | 88.61 | 88.61 | 0 | 99.47 | 0.1161 |
| Carbon dioxide | 37.58 | 3.667 | 0.6625 | 0.6625 | 3.667 | 0.004081 | 90.76 |
| Hydrogen sulphide | 0.9394 | 0.01652 | 0.7994 | 0.7994 | 0.01652 | 0.001101 | 2.267 |
| Water | 5.117 | 85.13 | 9.932 | 9.932 | 85.13 | 0.5277 | 6.862 |
| MEA | — | 11.19 | 0 | 0 | 11.19 | 0.000415 | 0 |

Utility Duties kW

| | |
|---|---|
| Compressor C1 | |
| Heater H1 | 750 |

### EXAMPLE VI

In this example the biogas of Example II is upgraded according to a process as exemplified in FIG. 4 at the conditions used in Example II and V. Stream properties and compositions as well as utility duties are as shown in Table VI, where the reference numbers are those of FIG. 4. The absorption agent is monoethanolamine (MEA) and the absorber of the first absorption step has a column height of 12 m and the absorber of the second absorption step has a column height of 4 m.

The first liquid effluent is in this example fed to the absorber of the second absorption step. The second liquid effluent is cooled to 35° C. prior to being fed to the absorber of the second absorption step.

The upgraded biogas contains 99.46 mole % methane and 39.6 ppm carbon dioxide and 10.6 ppm hydrogen sulphide, which on dry basis is 99.99 mole %, ppm and 10.6 ppm respectively, which is equal to that achieved in Example II and Example V.

As can be seen the flow rate of liquid absorption agent, sum of stream 201 and 212, is 18171 kg/h, which is about 962 kg/h lower than in Example V and 1062 lower than in Example II, which is also reflected in the reboiler duty being 725 kW compared to 750 kW in Examples II and V.

Hence, this example demonstrates that a configuration as shown in FIG. 4 allows for a reduction amount of absorbing agent used.

The methane slip in this example is about 8790 ppm, which could be lowered by flashing the high-pressure second effluent and recycling the resulting gas phase into the first absorber, and regenerating the resulting liquid phase in the regeneration system.

The example above may be further optimized to increase the resulting effect shown here. This is within the skill of the skilled practitioner.

TABLE VI

| | | 1^{st} Lean | First gas | Pressurized | 2^{nd} Lean | Upgraded | Waste |
|---|---|---|---|---|---|---|---|
| Name | Biogas | amine | effluent | biogas | amine | biogas | Off-gas |
| Reference | 101 | 201 | 105 | 107 | 212 | 108 | 114 |

Stream Properties

| | | | | | | | |
|---|---|---|---|---|---|---|---|
| Temperature C. ° | 35 | 35 | 53.08 | 40 | 35.27 | 35.8 | 50 |
| Pressure bar(a) | 1.1 | 4.5 | 1.1 | 11 | 22 | 11 | 1.8 |
| Mass flow kg/h | 1261.25 | 16171 | 539.97 | 539.97 | 2000 | 425.1 | 816.6 |

Stream Composition mole %

| | | | | | | | |
|---|---|---|---|---|---|---|---|
| Methane | 56.37 | 0 | 84.21 | 84.21 | 0 | 99.46 | 0.8790 |
| Carbon dioxide | 37.58 | 3.620 | 2.61 | 2.61 | 3.620 | 0.003962 | 90.01 |
| Hydrogen sulphide | 0.9394 | 0.01592 | 0.7759 | 0.7759 | 0.01592 | 0.001058 | 2.248 |
| Water | 5.117 | 85.20 | 12.40 | 12.40 | 85.20 | 0.5390 | 6.862 |
| MEA | — | 11.17 | 0 | 0 | 11.17 | 0.000416 | 0 |

Utility Duties kW

| | |
|---|---|
| Compressor C1 | |
| Heater H1 | 725 |

### LIST OF REFERENCES

Reference Name

101 Biogas stream

105 First gas effluent

107 Pressurized biogas stream

108 Second gas effluent

112 Dried biogas stream

113 Off-gas

114 Waste off-gas

115 Make-up water or fresh absorption liquid

201 First liquid absorption stream

202 First liquid effluent

206 Condensed liquid

212 Second liquid absorption stream

214 Second liquid effluent

214a Gas part of second liquid effluent

214b Liquid part of second liquid effluent

A1 Absorber of the first absorption step/First absorber

A2 Absorber of the second absorption step/Second absorber

C1 Compressor

H1 Heater (reboiler)

H2 Heat exchanger

H3 Heat exchanger

H4 Heat exchanger

H5 Heat exchanger

R Regeneration system

R1 Regeneration unit

P1 Pump

P2 Pump

P3 Pump

P4 Pump

U Upgrade system

What is claimed is:

1-27. (canceled)

28. A method for upgrading a biogas stream, the biogas stream comprising methane, carbon dioxide, and optionally hydrogen sulphide, the method comprising the steps of:
a. feeding the biogas stream and a first liquid absorption stream to an absorber of a first absorption step,
b. absorbing carbon dioxide and hydrogen sulphide if present, from the biogas stream into the first liquid absorption stream, thereby obtaining a first gas effluent and a first liquid effluent,
c. increasing the pressure of the first gas effluent, to obtain a pressurized biogas stream,
d. feeding the pressurized biogas stream and a second liquid absorption stream to an absorber of the second absorption step of a second absorption step,
e. absorbing carbon dioxide and hydrogen sulphide if present from the pressurized biogas stream into the second liquid absorption stream, thereby obtaining a second gas effluent and a second liquid effluent,
f regenerating the first liquid effluent and the second liquid effluent in a regeneration system, thereby obtaining a regenerated absorption stream,
g. providing the regenerated absorption stream in two streams to obtain the first liquid absorption stream and the second liquid absorption stream, and
h. recovering or further processing the second gas effluent as an upgraded biogas stream.

29. The method according to claim 28, wherein at least the first absorption step and second absorption step are performed in an upgrade system,
the first absorption step comprising the steps a. and b., and
the second absorption comprising the steps c., d., and e.,
wherein the biogas stream is fed to the upgrade system,
the regenerated absorption stream is fed to the upgrade system,
the upgraded biogas is recovered from the upgrade system, and
the first liquid effluent and second liquid effluent is fed from the upgrade system to the regeneration system.

30. The method according to claim 29, wherein one liquid absorption stream is provided to the upgrade system, the one stream being the regenerated absorption stream.

31. The method according to claim 28, wherein the upgrade system contains two absorption steps, the first and second absorption step.

32. The method according to claim 28, wherein either or both of the first and second absorption steps comprise two or more absorbers,
the two or more absorbers of the first absorption step having substantially the same operating pressure and
the two or more absorbers of the second absorption step having substantially the same operating pressure.

33. The method according to claim 28, further comprising a step of mixing the first and second liquid effluents.

34. The method according to claim 28, further comprising a step of feeding at least a part of the second liquid effluent to the absorber of the first absorption step, preferably at a lower section of the absorber.

35. The method according to claim 28, further comprising a step of feeding the first liquid effluent to the absorber of the second absorption step, preferably above a feeding point of the pressurized biogas stream, preferably at a midpoint of the second absorber.

36. The method according to claim 28, wherein carbon dioxide removed from the first liquid effluent and second liquid effluent is contained in an off-gas of the regeneration system.

37. The method according to claim 28, wherein step f. comprises heating the first liquid effluent and the second liquid effluent, to obtain the regenerated absorption stream.

38. The method according to claim 28, wherein the regeneration system comprises a stripper column with a reboiler.

39. The method according to claim 28, wherein the regeneration system comprises one single regeneration unit in which both the first and second liquid effluents are regenerated to provide the regenerated absorption stream, preferably wherein the regeneration unit is a stripper column with a reboiler.

40. The method according to claim 30, wherein the single regeneration unit provides the regenerated absorption stream as the only absorption liquid provided to the upgrade system.

41. The method according to claim 28, wherein the amount of carbon dioxide absorbed in step b. in to the first liquid absorption stream is greater than the amount of carbon dioxide absorbed in step e. into the second liquid absorption stream.

42. The method according to claim 28, wherein the flow rate of the first liquid absorption stream is greater than the flow rate of the second liquid absorption stream.

43. The method according to claim 42, wherein a total flow rate is the sum of the flow rates of the first and second liquid absorption streams,
and the flow rate of the second liquid absorption stream is 1 to 30% the total flow rate, such as 1 to 25%, 1 to 20%, 2 to 15%, 3 to 15%, 3 to 12%.

44. The method according to claim 28, wherein a ratio of the flow rate of biogas stream and the flow rate of the first liquid absorption stream, abbreviated GL1, is less than a ratio of the flow rate of first gas effluent and the flow of rate of the second liquid absorption stream, abbreviated GL2.

45. The method according to claim 44, wherein GL1 is less than 20%, less than 10%, suitably 1 to 20%, 2 to 15%, 2 to 10% or 4 to 8%.

46. The method according to claim 44, wherein GL2 is greater than 20% or greater than 30%, suitably in the range of 20 to 150%, 25 to 50% or 25 to 35%.

47. The method according to claim 28, wherein the operating pressure of the second absorption step is 4 to 70 bara, 4 to 40 bara, 6 to 40 bara, 10 to 30 bara, or 15 to 25 bara.

48. The method according to claim 28, wherein the operating pressure of the first absorption step is 0.7 to 6 bara, 1 to 6 bara, 1 to 4 bara, 1 to 2 bara, or 1 to 1.5 bara.

49. The method according to claim 28, wherein the first and second liquid absorption streams are chemical absorption streams.

50. The method according to claim 49, wherein the chemical absorption streams comprise an amine, preferably selected from monoethanolamine, diethanolamine, diisopropanolamine, methyldiethanolamine, triethanolamine, and piperazine.

51. The method according to claim 28, wherein the first and second liquid absorption streams are physical absorption streams.

52. The method according to claim 28, wherein the upgraded biogas stream comprises less than 50 ppm carbon dioxide and less than 4 ppm hydrogen sulphide on dry basis.

53. The method according to claim 28, wherein the upgraded biogas stream is further processed into liquified biogas.

54. A biogas upgrade system for upgrading a biogas stream, the system being configured for performing the method according to claim 28.
